(19) United States
(12) Patent Application Publication
(10) Pub. No.: US 2003/0151781 A1
(43) Pub. Date: Aug. 14, 2003

(54) Calibration device, caribration method of image output apparatus, program and recording medium

(75) Inventor: Youichi Ono, Akiruno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/359,936

(22) Filed: Feb. 6, 2003

(30) Foreign Application Priority Data
Feb. 13, 2002 (JP) JP2002-035624

(51) Int. Cl. B41J 1/00; H04N 1/46

(52) U.S. Cl. 358/504; 358/1.9

(57) ABSTRACT

A calibration device for calibrating an imaging apparatus, including

a first characteristic forming section to interpolate gradation measurement data so as to produce gradation interpolation data and to form a first characteristic between all driving levels and gradation data on a basis of gradation measurement data and the gradation interpolation data,

a correcting section to correct the first characteristic when the first characteristic does not show a monotonous increase or decrease in gradation data with increase of driving levels, and to form a second characteristic so as to show a monotonous increase or decrease in gradation data with increase of driving levels, and

a look-up table making section to make a look-up table showing relation between all driving levels and gradation data on the basis of the second characteristic so as to maintain predetermined relation between the inputted image data and the visual image.

### BACKGROUND OF THE INVENTION

The present invention relates to a calibration device that performs a calibration of an imaging apparatus, a calibration method of an imaging apparatus, a program and a recording medium.

The imaging apparatus such as a monitor or an imager changes a characteristic (gradation balance, for example) in accordance with a change of a condition, and as a result, it is difficult to show an image with a correct gradation. Due to this, when the condition is changed, it is necessary to perform a calibration process in order to match the changed characteristics.

A procedure of a method of this calibration will be described as follows.

Firstly, a chart for a correction is outputted on the imaging apparatus. Here, the chart for the correction means, for example, a gray chart on which driving levels of the imaging apparatus are shown to be different in each step. Then the outputted chart is read by a densitometer or luminance meter, and a density or luminance on each step is detected.

Since the detected density or luminance data (gradation measurement data) correspond to the gradations of each step only, a value between each gradation is interpolated based on the detected density or luminance data, to make characteristic data of the imaging apparatus. An interpolation method used here is, for example, Spline interpolation or Akima interpolation.

After the characteristic data of the imaging apparatus are obtained, a look-up table which shows a relation between the driving levels and the gradation levels of the image data is made and the outputted gradation levels are corrected in accordance with the look-up table so that the outputted levels of the density or luminance and the gradation level of the image data may become an intended gradation (nearly proportional, proportional to the driving level to the 2.2 power that is a ordinary characteristic of CRT, GSDF characteristics of DICOM PART 14, for example).

However, when the look-up table is made under the condition that the density or luminance data are not increasing monotonously or not decreasing monotonously, or under the condition that interpolated density or luminance data d, as shown in FIG. 11, are not increasing monotonously or not decreasing monotonously, though the density or luminance data are increasing monotonously or decreasing monotonously, concave section L of a characteristic curve is disregarded so that the correction values of each density or luminance become discontinuous, having gap L, as shown in FIG. 12. Due to this, when the output data are obtained by the look-up table, there is a fear that a false contour is generated, when the image is displayed.

### SUMMARY OF THE INVENTION

The object of the present invention is to provide a calibration device being capable of preventing occurrence of the false contour, a calibration method of the imaging apparatus, a program, and a memory medium. The objects of the present invention are attained by the following Structures.

Structure (1)

A calibration device for calibrating an imaging apparatus which outputs a visual image in response to inputted image data, on a basis of a plurality of driving test levels and a plurality of gradation measurement data obtained by measuring a plurality of visual images corresponding to the plurality of driving test levels, including:

a first characteristic forming section to interpolate the plurality of gradation measurement data so as to produce a plurality of gradation interpolation data and to form a first characteristic between all driving levels and gradation data on a basis of both of the plurality of gradation measurement data and the plurality of gradation interpolation data;

a correcting section to correct the first characteristic in the case that the first characteristic does not show a monotonous increase or decrease in the gradation measurement data with increase of the driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level; and

a look-up table making section to make a look-up table showing relation between all driving levels and inputted image data on the basis of the second characteristic so as to maintain predetermined relation between the inputted image data and the outputted visual images.

According to Structure (1), the correcting section corrects the first characteristic, in the case that the first characteristic does not show a monotonous increase or decrease in the gradation measurement data with increase of the driving levels, and forms a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level. Accordingly, since the second characteristic formed after the correction shows either one relation of a monotonous increase or a monotonous decrease, the correction values do not become discontinuous, when the look-up table is formed based on the second characteristic data. Accordingly, when the image data are corrected by the formed look-up table, it is possible to output the image in which a false contour is not generated.

Here, “monotonous increase” means that progression “an” satisfies a1<a2<a3< - - - <an, and “monotonous decrease” means that progression “an” satisfies a1>a2>a3> - - - >an.

Structure (2)

The calibration device described in Structure (1),

wherein when the gradation data shown in the first characteristic has the increasing tendency,

the correcting section forms the second characteristic by performing at least either one of corrections to the first characteristic, which are

an increasing correction wherein, between adjoining gradation measurement data of a decreased section of the gradation interpolation data with the increase of the driving level, the gradation measurement datum corresponding to a higher driving level is increased up to the level where the relation shown in the characteristic becomes the monotonous increase, and

a decreasing correction wherein, between adjoining gradation measurement data of a decreased section of the gradation interpolation data with the increase of the driving level, the gradation measurement datum corresponding to a lower driving level is decreased down to the level where the relation shown in the characteristic becomes the monotonous increase, on the other hand, when the gradation data shown in the first characteristic has a decreasing tendency,

the correcting section forms the second characteristic by performing at least either one of corrections to the first characteristic, which are

a decreasing correction wherein between adjoining gradation measurement data of an increased section of the gradation interpolation data with the increase of the driving level, the gradation measurement datum corresponding to a higher driving level is decreased down to the level where the relation shown in the characteristic becomes the monotonous decrease, and

an increasing correction, wherein between adjoining gradation measurement data of an increased section of the gradation interpolation data with the increase of the driving level, the gradation measurement datum corresponding to a lower driving level is increased up to the level where the relation shown in the characteristic becomes the monotonous decrease.

The invention described in Structure (2) makes it possible to obtain an effect which is the same as that of the invention described in Structure (1).

Structure (3)

The calibration device described in Structure (2), wherein the correcting section corrects the gradation measurement datum, based on the datum before the correction of the gradation measurement datum, and a plurality of neighboring gradation measurement data.

The invention described in Structure (3) makes it possible to obtain an effect which is the same as that of the invention described in Structure (2).

Structure (4)

The calibration device described in Structure (1), wherein when the correcting section corrects the gradation measurement data,

in case that the gradation measurement data shown in the characteristic have an increasing tendency, the correcting section performs smoothing of a plurality of the gradation measurement data, until the relation in the second characteristic becomes a monotonous increase, on the other hand,

in case that the gradation measurement data shown in the characteristic have a decreasing tendency, the correcting section performs smoothing of a plurality of the gradation measurement data, until the relation in the second characteristic becomes a monotonous decrease.

According to the invention described in Structure (4), it is possible to obtain an effect which is the same as that of the invention described in Structure (1). Incidentally, in the constructions of Structures (2), and (3), there is a possibility that a correcting amount of the gradation measurement data to be corrected is large, though the number of the gradation measurement data to be corrected is small, however,

in the construction of Structure (4), there is a possibility that a correcting amount of the gradation measurement data to be corrected is small, though the number of the gradation measurement data to be corrected is large.

Structure (5)

The calibration device described in either one of Structures 1) to (4), wherein, in case that the relation in the first characteristic has the increasing tendency, and further there is a section where the gradation measurement data decrease with the increase of the driving level,

when the section where the gradation measurement data decrease, corresponds to the driving level that is higher than the driving level wherein the gradation measurement datum has a maximum value, the correcting section does not perform the monotonous increasing correction to the first characteristic, on the other hand,

wherein in case that the relation in the first characteristic has the decreasing tendency, and further there is a section where the gradation measurement data increase with the increase of the driving level,

when the section where the gradation measurement data increase, corresponds to the driving level that is higher than the driving level wherein the gradation measurement datum has a minimum value, the correcting section does not perform the monotonous decreasing correction for the first characteristic; and

the look-up table making section makes the look-up table based on the second characteristic wherein the second characteristic is not the monotonous increase or the monotonous decrease.

The invention described in Structure (5) makes it possible to obtain an effect which is the same as that of the invention described in Structures (1) to (4) . Further, in the case of the above-mentioned increasing tendency, when the decreasing section of the gradation level exists on a section whose driving level is higher than the driving level which gives a maximum value of the density or luminance level, the false contour is not generated, because the gradation level that is higher than the maximum value does not exist, though the decreasing section of the gradation level is disregarded.

Similarly, in the case of the above-mentioned decreasing tendency, when the increasing section of the gradation level exists on a section whose driving level is higher than the driving level which gives a minimum value of the gradation level, the false contour is not generated, because the gradation level that is lower than the minimum value does not exist, though the increasing section of the gradation level is disregarded.

Accordingly, in the above-mentioned case, even when the look-up table is made without correcting the gradation measurement data, the gradation measurement data are not corrected, because the false contour is not generated; and thereby, the process is simplified so that the time for the process can be shortened.

Structure (6)

The calibration device described in either one of Structures (1) to (5), having a warning section which performs a warning process, when the gradation measurement data beyond a predetermined range is adopted to the gradation measurement data.

According to Structure (6), when the gradation measurement data are corrected beyond the predetermined range, there is a high possibility of an abnormal condition, for example, that the gradation of the output image was not read out correctly under the influence of light such as an illumination light in the course of the gradation measurement. In this case, however, if the gradation of the output image is detected again, by giving a warning and by changing the detecting circumstance and the detecting condition for the gradation, for example, the more accurate look-up table can be made.

Structure (7)

A calibration device which performs calibration of an imaging apparatus that outputs a visual image in response to inputted image data, on a basis of a plurality of driving test levels and a plurality of gradation measurement data obtained by measuring a plurality of visual images corresponding to the plurality of driving test levels, including;

a first characteristic forming section to interpolate the plurality of gradation measurement data so as to produce a plurality of gradation interpolation data and to form a first characteristic between all driving levels and gradation data on a basis of both of the plurality of gradation measurement data and the plurality of gradation interpolation data;

a look-up table making section to make a look-up table showing relation between all driving levels and inputted image data, based on the first characteristic so as to maintain predetermined relation between the inputted image data and the outputted visual images; and

a warning process section for performing a warning process, before making the look-up table,

when the first characteristic shows an increasing tendency of the gradation measurement data with the increase of the driving level, and shows that the gradation measurement data are not monotonous increase, or when the characteristic shows a decreasing tendency of the gradation measurement data with the increase of the driving level, and shows that the density or luminance data are not a monotonous decrease.

According to Structure (7), when the characteristic formed in the first characteristic forming section shows that the gradation measurement data have the increasing tendency with the increase of the driving levels, and shows that the gradation measurement data are not the monotonous increase, or when the first characteristic formed in the first characteristic forming section shows that the gradation measurement data have the decreasing tendency with the increase of the driving levels, and shows that the gradation measurement data are not the monotonous decrease, the warning process section raises an alarm so that the gradation of the image can be detected again, before the look-up table which will cause the false contour is made. Further, if the above-mentioned circumference is created by the circumference or the condition in the course of the detection, it is possible to prevent the generation of the false contour when the image is outputted, by changing the detecting circumference and the detecting condition for re-detection.

Structure (8)

A calibration method of an imaging apparatus, including;

a gradation measurement data detecting step for reading out gradation measurement data of visual images outputted by an imaging apparatus;

a first characteristic forming step to interpolate a plurality of the gradation measurement data so as to produce a plurality of gradation interpolation data and to form a first characteristic between all driving levels and gradation data on a basis of both of the plurality of gradation measurement data and the plurality of gradation interpolation data;

a correcting step to correct the first characteristic in the case that the first characteristic does not show a monotonous increase or decrease in the gradation measurement data with increase of driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in the gradation data with the increase of the driving level, though the first characteristic has a decreasing tendency, but is not the monotonous decrease with the increase of the driving level; and

a look-up table making step to make a look-up table showing relation between all driving levels and inputted image data on the basis of the second characteristic so as to maintain predetermined relation between the inputted image data and the outputted visual images.

According to the invention described in Structure (8), it is possible to obtain an effect which is the same as that of the invention described in Structure (1).

Structure (9)

A calibration method of the image processing apparatus, having,

a gradation measurement data detecting step for reading out gradation measurement data of visual images outputted in response to inputted image data, on a basis of a plurality of driving test levels and a plurality of gradation measurement data obtained by measuring a plurality of visual images corresponding to the plurality of the driving test levels, including;

a first characteristic forming step to interpolate the plurality of the gradation measurement data so as to produce a plurality of gradation interpolation data and to form a first characteristic between all driving levels and gradation data on a basis of both of the plurality of the gradation measurement data and the plurality of gradation interpolation data;

a look-up table making step for making a look-up table showing the relation between the driving level and a gradation of the inputted image data, based on the first characteristic; and

a warning process step for performing a warning process, before making the look-up table,

when the first characteristic shows an increasing tendency of the gradation measurement data with an increase of the driving level, and shows that the gradation measurement data are not a monotonous increase, or

when the first characteristic shows a decreasing tendency of the gradation measurement data with the increase of the driving level, and shows that the gradation measurement data are not a monotonous decrease.

According to the invention described in Structure (9), it is possible to obtain an effect which is the same as that of the invention described in Structure (7).

Structure (10)

A program that makes a computer to perform calibration process of the imaging apparatus, based on

a first characteristic forming function to interpolate the plurality of gradation measurement data so as to produce a plurality of gradation interpolation data and to form a first characteristic between all driving levels and gradation data on a basis of both of the plurality of gradation measurement data and the plurality of gradation interpolation data;

a correcting function to correct the first characteristic in the case that the first characteristic does not show a monotonous increase or decrease in the gradation measurement data with increase of the driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level; and

a look-up table making function to make a look-up table showing relation between all driving levels and inputted image data on the basis of the second characteristic so as to maintain predetermined relation between the inputted image data and the outputted visual images.

According to the invention described in Structure (10), it is possible to obtain an effect which is the same as that of the invention described in Structure (1).

Structure (11)

A program that makes a computer to perform calibration process of the imaging apparatus, based on

a first characteristic forming function to interpolate the plurality of gradation measurement data so as to produce a plurality of gradation interpolation data and to form a first characteristic between all driving levels and gradation data on a basis of both of the plurality of gradation measurement data and the plurality of gradation interpolation data;

a look-up table making function for making a look-up table showing relation between all driving levels and inputted image data, based on the first characteristic so as to maintain predetermined relation between the inputted image data and the outputted visual images; and

a warning process function for performing a warning process, before making the look-up table,

when the first characteristic shows an increasing tendency of the gradation measurement data with the increase of the driving level, and shows that the gradation measurement data are not a monotonous increase, or

when the first characteristic shows a decreasing tendency of the gradation measurement data with the increase of the driving level, and shows that the gradation measurement data are not a monotonous decrease.

According to Structure (11), it is possible to obtain an effect which is the same as that of the invention described in Structure (7).

Structure (12)

A calibration device for calibrating an imaging apparatus which outputs a visual image in response to inputted image data, on a basis of a plurality of driving levels and a plurality of gradation measurement data obtained by measuring a plurality of visual images corresponding to the plurality of driving levels, including;

a first characteristic forming section to form a first characteristic between gradation measurement data and the plurality of the driving levels;

a correcting section to correct the first characteristic in the case that the first characteristic does not show a monotonous increase or decrease in gradation measurement data with increase of driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level; and

a look-up table making section to make a look-up table showing relation between driving levels and inputted image data on the basis of the second characteristic so as to maintain predetermined relation between the inputted image data and the outputted visual images.

According to Structure (12), the correcting section corrects the first characteristic, in the case that the first characteristic does not show a monotonous increase or decrease in the gradation measurement data with increase of the driving levels, and forms a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level. Accordingly, since the second characteristic formed after the correction show either one relation of a monotonous increase or a monotonous decrease, the correction values do not become discontinuous, when the look-up table is formed based on the second characteristic data. Accordingly, when the image data are corrected by the formed look-up table, it is possible to output the image in which a false contour is not generated.

Structure (13)

The calibration device described in Structure (12),

wherein when the first characteristic has the increasing tendency,

the correcting section forms the second characteristic by performing at least either one of corrections to the first characteristic, which are

an increasing correction, wherein when the gradation measurement data do not increase monotonously with the increase of the driving level, the gradation measurement datum corresponding to a higher driving level is increased up to the level where the relation shown in the characteristic becomes the monotonous increase, and

a decreasing correction, wherein when the gradation measurement data do not decrease monotonously with the increase of the driving level, the gradation measurement datum corresponding to a lower driving level is decreased down to the level where the relation shown in the characteristic becomes the monotonous increase,

on the other hand, when the gradation data shown in the first characteristic has a decreasing tendency,

the correcting section forms the second characteristic by performing at least either one of corrections to the first characteristic, which are

a decreasing correction, wherein when the gradation measurement data do not decrease monotonously with the increase of the driving level, the gradation measurement datum corresponding to a higher driving level is decreased down to the level where the relation shown in the characteristic becomes the monotonous decrease, and

an increasing correction, wherein when the gradation measurement data do not decrease monotonously with the increase of the driving level, the gradation measurement datum corresponding to a lower driving level is increased up to the level where the relation shown in the characteristic becomes the monotonous decrease.

According to the invention described in Structure (13), it is possible to obtain an effect which is the same as that of the invention described in Structure (12).

Structure (14)

The calibration device described in Structure (13), wherein the correcting section corrects the gradation measurement datum, based on the datum before the correction of the gradation measurement datum, and a plurality of neighboring gradation measurement data.

According to Structure (14), it is possible to obtain an effect which is the same as that of the invention described in Structure (13).

Structure (15)

The calibration device described in Structure (12), wherein when the correcting section corrects the detected density or luminance data,

in case that the gradation measurement data shown in the characteristic have an increasing tendency, the correcting section performs smoothing of a plurality of the gradation measurement data, until the relation in the characteristic becomes a monotonous increase, on the other hand, in case that the gradation measurement data shown in the characteristic have a decreasing tendency, the correcting section performs smoothing of a plurality of the gradation measurement data, until the relation in the characteristic becomes a monotonous decrease.

According to Structure (15), it is possible to obtain an effect which is the same as that of the invention described in Structure (12). Incidentally, in the constructions of Structures (13) and (14), there is a possibility that a correcting amount of the density or luminance data to be corrected is large, though the number of the density or luminance data to be corrected is small, however, in the construction of Structure (15), there is a possibility that a correcting amount of the gradation measurement data to be corrected is small, though the number of the gradation measurement data to be corrected is large.

Structure (16)

The calibration device described in either one of Structures (12) to (15),

wherein, in case that the relation in the first characteristic has the increasing tendency, and further there is a section where the gradation measurement data decrease with the increase of the driving level,

when the section where the gradation measurement data decrease, corresponds to a driving level that is higher than the driving level wherein the density or luminance datum has a maximum value, the correcting section does not perform the monotonous increasing correction of the characteristic data, on the other hand,

when the relation expressed in the characteristic data has the decreasing tendency, and further there is a section where the gradation measurement data increase with the increase of the driving level,

when the section where the density or luminance data increase, corresponds to the driving level that is higher than the driving level wherein the gradation measurement datum has a minimum value, the correcting section does not perform the monotonous decreasing correction of the first characteristic, and the look-up table forming section forms the look-up table, based on the second characteristic wherein the second characteristic is not the monotonous increase or the monotonous decrease.

According to Structure (16), it is possible to obtain an effect which is the same as that of the invention described in Structures (12) to (15).

Further, in the case of the above-mentioned increasing tendency, when the decreasing section of the gradation level exists on a section whose driving level is higher than the driving level which gives a maximum value of the density or luminance level, the false contour is not generated, because the gradation level that is higher than the maximum value does not exist, though the decreasing section of the gradation level is disregarded.

Similarly, in the case of the above-mentioned decreasing tendency, when the increasing section of the gradation level exists on a section whose driving level is higher than the driving level which gives a minimum value of the gradation level, the false contour is not generated, because the gradation level that is lower than the minimum value does not exist, though the increasing section of the gradation level is disregarded.

Accordingly, in the above-mentioned case, even when the look-up table is made without correcting the gradation measurement data, the gradation measurement data are not corrected, because the false contour is not generated, and thereby, the process is simplified so that the time for the process can be shortened.

Structure (17)

The calibration device described in either one of Structures (12) to (16), including a warning section which performs a warning process, when the gradation measurement data beyond the predetermined range is adopted to the gradation measurement data.

According to Structure (17), when the gradation measurement data are corrected beyond the predetermined range, there is a high possibility of an abnormal condition, for example, that the gradation of the output image was not read out correctly under the influence of light such as an illumination light in the course of the gradation measurement. In this case, however, if the gradation of the output image is detected again, by giving a warning and by changing the detecting circumstance and the detecting condition for the gradation, for example, the more accurate look-up table can be made

Structure (18)

A calibration device which performs calibration of an imaging apparatus that outputs a visual image in response to inputted image data, on a basis of a plurality of driving levels and a plurality of gradation measurement data obtained by measuring a plurality of visual images corresponding to the plurality of driving test levels, including;

a first characteristic forming section to form a first characteristic between all driving levels and the gradation measurement data;

a look-up table making section for make a look-up table showing relation between driving levels and inputted image data, based on the first characteristic so as to maintain predetermined relation between the inputted image data and the outputted visual images; and

a warning process section for performing a warning process, before making the look-up table,

when the first characteristic shows an increasing tendency of the gradation measurement data with the increase of the driving level, and shows that the gradation measurement data are not monotonous increase, or when the characteristic shows a decreasing tendency of the gradation measurement data with the increase of the driving level, and shows that the density or luminance data are not a monotonous decrease.

According to Structure (18), when the characteristic formed in the first characteristic forming section shows that the gradation measurement data have the increasing tendency with the increase of the driving levels, and shows that the gradation measurement data are not the monotonous increase, or when the first characteristic formed in the first characteristic forming section shows that the gradation measurement data have the decreasing tendency with the increase of the driving levels, and shows that the gradation measurement data are not the monotonous decrease, the warning process section raises an alarm so that the gradation of the image can be detected again, before the look-up table which will cause the false contour is made. Further, if the above-mentioned circumference is created by the circumference or the condition in the course of the detection, it is possible to prevent the generation of the false contour when the image is outputted, by changing the detecting circumference and the detecting condition for re-detection.

Structure (19)

A calibration method of an imaging apparatus in Structure (8), including;

a gradation measurement data detecting step for reading out gradation measurement data of visual images outputted by an imaging apparatus;

a first characteristic forming step to form a first characteristic on a basis of both of the plurality of gradation measurement data and the plurality of driving levels;

a correcting step to correct the first characteristic in the case that the first characteristic does not show a monotonous increase or decrease in the gradation measurement data with increase of driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in the gradation data with the increase of the driving level, though the first characteristic has a decreasing tendency, but is not the monotonous decrease with the increase of the driving level; and a look-up table making step to make a look-up table showing relation between driving levels and inputted image data on the basis of the second characteristic so as to maintain predetermined relation between the inputted image data and the outputted visual images.

According to Structure (19), it is possible to obtain an effect which is the same as that of the invention described in Structure (12).

Structure (20)

A calibration method of the image processing apparatus described in Structure (9), having,

a gradation measurement data detecting step for reading out gradation measurement data of visual images outputted in response to inputted image data, on a basis of a plurality of driving levels and a plurality of gradation measurement data obtained by measuring a plurality of visual images corresponding to the plurality of the driving levels, including;

a first characteristic forming step to form a first characteristic on a basis of both of the plurality of the gradation measurement data and the plurality of driving levels;

a look-up table making step for making a look-up table showing the relation between the driving level and a gradation of the inputted image data, based on the first characteristic; and

a warning process step for performing a warning process, before making the look-up table,

when the first characteristic shows an increasing tendency of the gradation measurement data with an increase of the driving level, and shows that the gradation measurement data are not a monotonous increase, or

when the first characteristic shows a decreasing tendency of the gradation measurement data with the increase of the driving level, and shows that the gradation measurement data are not a monotonous decrease

According to Structure (20), it is possible to obtain an effect which is the same as that of the invention described in Structure (18).

### BRIEF DESCRIPTION OF THE DRAWINGS

FIG. 1 is a main control block diagram showing a main section of a personal computer having an imaging apparatus of an embodiment to which the present invention is applied.

FIG. 2 is a flow chart showing a calibration method which is performed to the imaging apparatus shown in FIG. 1.

FIG. 3 is a gradation-luminance diagram showing characteristic data obtained by the calibration method shown in FIG. 2.

FIG. 4 is a flow chart showing an example of a variation of the calibration method shown in FIG. 3.

FIG. 5 is a gradation-luminance diagram showing characteristic data obtained by the calibration method shown in FIG. 4.

FIG. 6 is a flow chart showing an example of a variation of the calibration method shown in FIG. 3.

FIG. 7 is a flow chart showing an example of a variation of the calibration method shown in FIG. 3.

FIG. 8 is a gradation-luminance diagram showing characteristic data obtained by the calibration method shown in FIG. 7.

FIG. 9 is a flow chart showing an example of a variation of the calibration method shown in FIG. 3.

FIG. 10 is a gradation-luminance diagram showing characteristic data obtained by the calibration method shown in FIG. 9.

FIG. 11 is a gradation-luminance diagram showing characteristic data obtained by a conventional method.

FIG. 12 is a correction value-gradation diagram showing a look-up table obtained by the characteristic data shown in FIG. 11.

### DETAILED DESCRIPTION OF THE PREFERRED EMBODIMENT

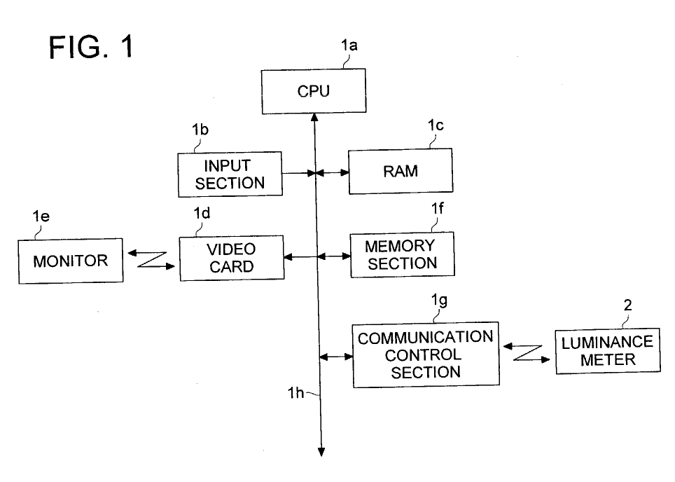

The embodiments of the present invention will be described as follows, referring to the drawings shown in FIGS. 1 to 10.

Although the calibration device of the present invention is, for example, the one which performs calibration to a monitor connected to a personal computer or an imager, the present embodiment is described, by exemplifying the personal computer which performs calibration to the monitor as the calibration device.

As shown in FIG. 1, personal computer 1 has CPU (central processing unit) la that performs central control for each section, input section 1b on which an operator inputs information, RAM (Random Access Memory) 1c which stores information temporarily, monitor 1e (an image output device) which is connected through video card 1d and displays information to the operator, memory section if which memorizes information, communication control section 1g which controls sending and receiving of information to luminance mater (luminance reading means) 2, and bus 1h which connects the CPU 1a, the input section 1b, the RAM 1c, the video card 1d, the memory section 1f, and the communication control section 1g.

The CPU 1a develops the program, which is designated among the various programs stored in the memory section 1f, in a working area in RAM 1c, and performs the various processes according to the program.

The input section 1b includes, for example, a key board having a cursor key, numeric keys, and various function keys, and a mouse or tablet as a pointing device, and outputs a signal generated by a press by the operator on the keyboard or a signal that shows a position generated by a mouse, to CPU 1a.

The RAM 1c is a memory for memorizing the various conditions, the RAM 1c has a memory area in which various programs, input instruction, and various data such as input data and processed result are stored to be capable of an random access expansion by CPU 1a.

The video card 1d has a controller that controls an output of an image, and has VRAM that memorizes the image to be outputted temporally, and outputs the image signal on the monitor 1e, based on the image data developed in VRAM.

The monitor 1eis composed of CRT (Cathode Ray Tube) or LCD (Liquid Crystal Display), and displays the various display data according to the image signal of the video card 1d which is inputted based on the control of the CPU 1a.

The memory section 1f has recording media (not illustrated) in which program or data are memorized or can be written beforehand, and the recording media are composed of a magnetic or optical recording media, or recording media which can be read by CPU 1a, represented by a nonvolatile memory such as a semiconductor. The recording media include a hard disk installed to be fixed, or a CD-ROM and a memory card which are removable and portable.

The memory section 1f stores the various processing programs and the various data such as the data which are to be processed or have been processed by the programs. The RAM 1c and the memory section 1f are structured in a manner that the internal data can be rewritten by the control of the CPU 1a.

Further, concerning the program and the data memorized in the memory section 1f, they can be structured in a manner that a part of them or all of them can be stored, after being received from the communication control section 1g through communication networks such as LAN, WAN, and the Internet, from an external device, and further, the memory section 1f can be a memory device of an external device structured on the communication network. Still further, the above-mentioned various programs can be structured in a manner that they are sent to the external device through the communication network to be installed.

The communication control section 1g is the one which communicates with the external device, and to which the external device is connected through RS-232C interface or USB.

The luminance meter 2 is the one which detects the luminance of the outputted image, and the detected luminance data are outputted to the RAM 1c through the communication control section 1g to be memorized.

Next, the calibration method which is performed to the monitor 1e of the present embodiment is described below.

The calibration method is composed of a luminance detecting step for detecting the luminance of a gray scale displayed on the monitor 1e, a characteristic data forming step for forming the characteristic data of the monitor 1e, based on the detected luminance data (gradation measurement data), a correction step for correcting the characteristic data, and a look-up table forming step for forming the look-up table, based on the characteristic data, wherein the outputted data are corrected so as to be suitable for the monitor 1e, by the look-up table obtained by the above mentioned steps, and the gradation process is performed.

A series of these processes are performed by the personal computer 1, that is, the CPU 1a of the personal computer 1 has the functions for a characteristic data forming means, a correcting means, and a look-up table forming means.

In the luminance detecting step, firstly, the CPU 1a makes the monitor 1e to display the gray chart memorized in the memory section 1f. The driving levels of the monitor 1e are established to be different at even intervals in each step of the gray chart, and each step is the luminance measurement image which is for the measurement of the luminance of the monitor 1e. That is, a plurality of patterns (outputted images) formed by the various driving levels are displayed on the monitor 1e. When the gray chart is displayed on the monitor 1e, the operator detects the luminance of each step of the displayed gray chart with the luminance meter 2. Here, the luminance data which have been detected (the detected luminance data) are memorized in the RAM 1c.

Incidentally, here, there is exemplified the case that the driving levels are different on each step of the gray chart at even intervals, however, it is also possible to establish the way in which a lower luminance side has more measuring points than a higher luminance side, for example, because a dark side is more sensitive for the change of the luminance than a light side as visual characteristics, generally.

In the first characteristic data forming step, characteristic data S of the monitor 1e are formed, by the manner that the luminance data of driving level section which are not used for the gray chart are interpolated, based on the detected luminance data (gradation measurement data) and the driving level of the pattern which are memorized in the RAM 1c. Concerning the interpolation performed here, there is used a calculation method, wherein after obtaining functional values for two or more variables, the functional value or an approximate value for an optional variable between the valuables is obtained, and Spline interpolation and Akima interpolation, for example, are listed as this calculation method. The characteristic data obtained here show the relation between the luminance data and the driving levels.

In the correction step, the correcting step forms the second characteristic data of the monitor 1e again, by correcting the detected luminance data in a way that the increase of the luminance data after an interpolation becomes monotonous increase, when the luminance data after the interpolation have an increasing tendency with the increase of the driving level, but the luminance data after the interpolation do not show a monotonous increase, on the other hand, the correcting step forms the second characteristic data of the monitor 1e, by correcting the detected luminance data in a way that the decrease of the luminance data after an interpolation becomes monotonous decrease, when the luminance data after the interpolation have a decreasing tendency with the increase of the driving level, but the luminance data after the interpolation do not show a monotonous decrease.

The correction method performed in the correction step will be described below referring to the examples. Incidentally, though there is exemplified the case that the luminance data after the interpolation show an increasing tendency with the increase of the driving level, in the first characteristic data formed in the characteristic data forming step, the correction method having the same idea as the above case is also used in the case that the luminance data after the interpolation show a decreasing tendency with the increase of the driving level, in the first characteristic data.

### EXAMPLE 1

Example 1 shows the method of the correction. That is, when the luminance data (gradation measurement data) shown in the first characteristic data formed in the first characteristic forming step have the increasing tendency, between adjoining pairs of the detected luminance data with a decreased section of the interpolated luminance data being between, with the increase of the driving level, an increasing correction is conducted so that the detected luminance datum corresponding to a higher driving level is increased up to level where the relation shown in the characteristic data becomes a monotonous increase.

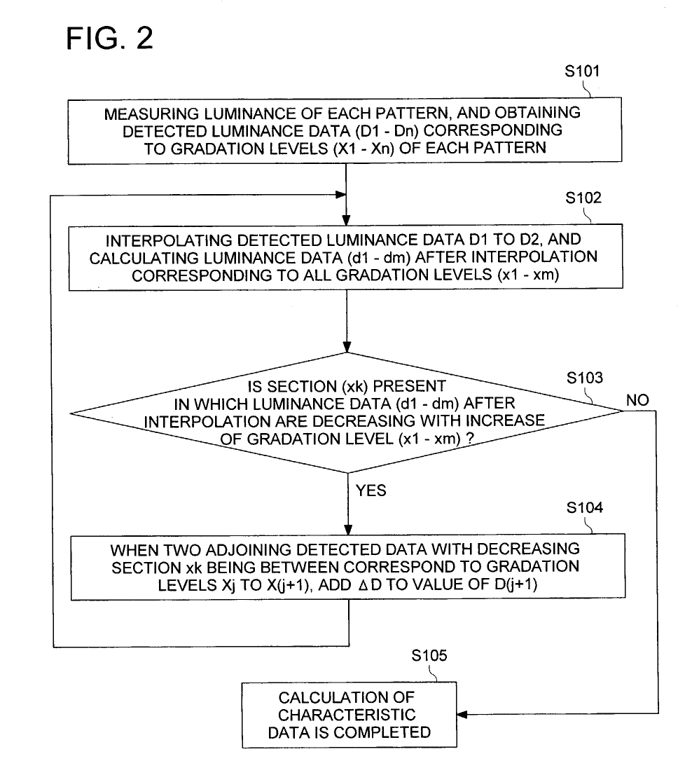

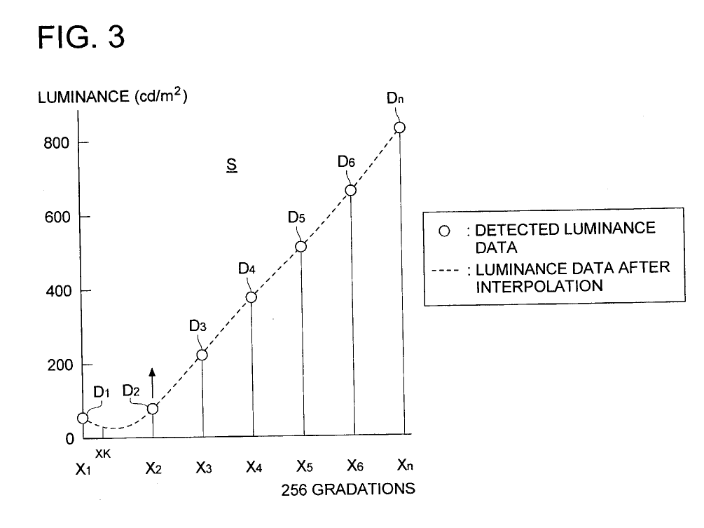

To put it concretely, as shown in FIG. 2, when the detected luminance data (D1to Dn) corresponding to the driving levels X1 to Xn of each pattern are detected by the luminance meter 2, and memorized in the RAM 1c (step S101: luminance detecting step), the CPU 1a interpolates the luminance data corresponding to all of the driving levels (x1 to Xm) of the monitor 1e to obtain the interpolated luminance data (d1 to dm), based on the detected data and the gradation of each pattern, (step S102: characteristic data forming step), and proceeds to step S103. FIG. 3 is a gradation luminance diagram showing the luminance data after the interpolation and the detected luminance data.

In step S103, CPU 1a judges whether section xk decreasing with the increase of the driving level exists in the interpolated luminance data or not, and when there exists the decreasing section xk, CPU 1a proceeds to step S104, and if not, CPU 1a proceeds to step S105 to complete the calculation of the characteristic data S.

Further, in step S104, if a pair of two detected luminance data with the decreasing section xk between correspond to the driving levels Xj to X(j+1), the CPU 1a increases the value of the detected luminance datum D(j+1), which corresponds to the driving level X(j+1) having a higher value, by ΔD, and CPU 1a proceeds to step S102. Here, AD is a predetermined constant value.

As mentioned above, in the Example 1, when there exists the section xk decreasing with the increase of the driving level, the increasing correction, wherein the detected luminance datum D (j+1) is added by a constant value, is repeated to correct the detected luminance data, until the relation shown in the characteristic data S becomes the monotonous increase.

Incidentally, when the luminance data after the interpolation shown in the characteristic data has a decreasing tendency with the increase of the driving level, between adjoining pairs of the detected luminance data with an increased section of the interpolated luminance data being between, with the increase of the driving level, a decreasing correction is conducted so that the detected luminance datum corresponding to a higher driving level is decreased down to the level where the relation shown in the characteristic data becomes a monotonous decrease.

### EXAMPLE 2

Example 2 shows the method of the correction. That is, when the luminance data (gradation measurement data) shown in the first characteristic data formed in the characteristic data forming step have the increasing tendency, between adjoining pairs of the detected luminance data with a decreased section of the interpolated luminance data being between, with the increase of the driving level, a decreasing correction is conducted so that the detected luminance datum corresponding to a higher driving level is decreased down to the level where the relation shown in the characteristic data becomes a monotonous increase.

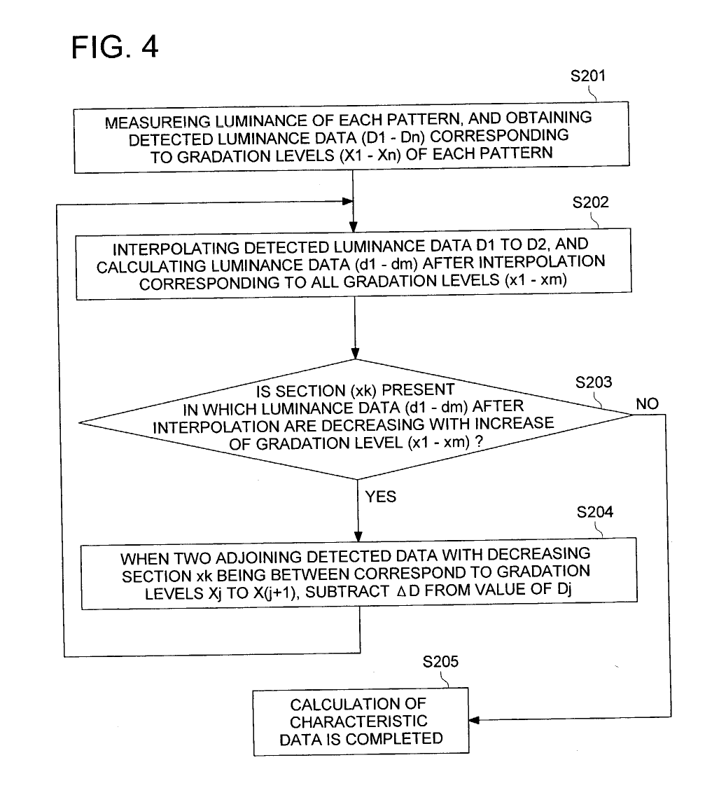

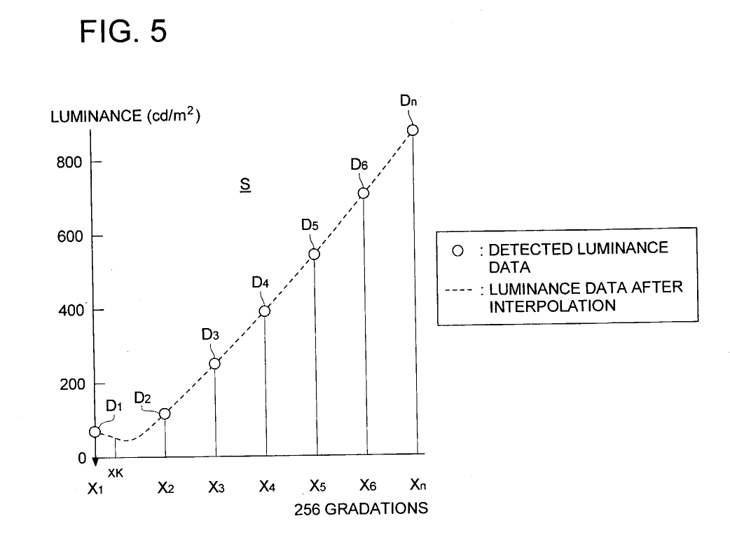

To put it concretely, as shown in FIG. 4, when the luminance data (D1 to Dn), when the detected luminance data (D1 to Dn) corresponding to the driving levels X1 to Xn of each pattern are detected by the luminance meter 2, and memorized in the RAM 1c (step S201: luminance detecting step), the CPU 1a interpolates the luminance data corresponding to all of the driving levels (x1 to Xm) of the monitor 1e to obtain the interpolated luminance data (d1 to dm), based on the detected data and the gradation of each pattern, (step S202: characteristic data forming step), and proceeds to step S203. FIG. 5 is a gradation-luminance diagram showing the luminance data after the interpolation and the detected luminance data.

In step S203, CPU 1a judges whether section xk decreasing with the increase of the driving level exists in the interpolated luminance data or not, and when there exists the decreasing section xk, CPU 1a proceeds to step S204, and if not, CPU 1a proceeds to step S205 to complete the calculation of the characteristic data.

Further, in step S204, if a pair of two detected luminance data with the decreasing section xk between correspond to the driving levels Xj to X(j+1), the CPU 1a decreases the value of the detected luminance datum Dj, which corresponds to the driving level Xj having a higher value, by ΔD, and CPU 1a proceeds to step S202. Here, AD is a predetermined constant value.

As mentioned above, in the Example 2, when there exists the section xk decreasing with the increase of the driving level, the decreasing correction, wherein the detected luminance datum Dj is decreased by a constant value, is repeated to correct the detected luminance data, until the relation shown in the characteristic data S becomes the monotonous increase.

Incidentally, when the luminance data after the interpolation shown in the characteristic data has a decreasing tendency with the increase of the driving level, between adjoining pairs of the detected luminance data with an increased section of the interpolated luminance data being between, with the increase of the driving level, a decreasing correction is conducted so that the detected luminance datum corresponding to a higher driving level is decreased down to the level where the relation shown in the characteristic data becomes a monotonous decrease.

### EXAMPLE 3

Though the changing value ΔD of the detected luminance data (gradation measurement data) is a predetermined constant value in Example 1 or 2, the changing value ΔD is determined based on the datum before the correction of the detected luminance data, and a plurality of neighboring detected luminance data.

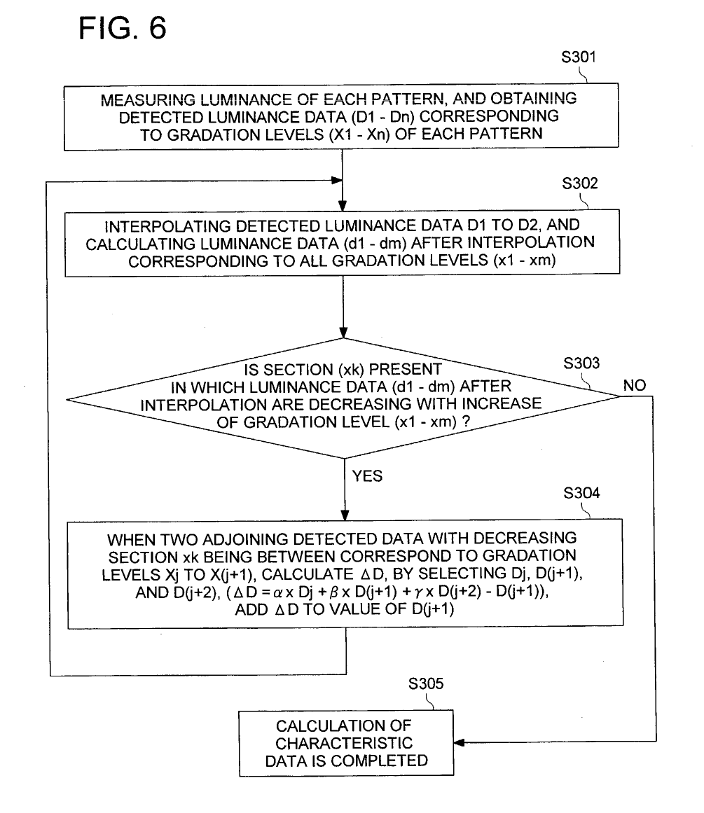

To put it concretely, as shown in FIG. 6, when the detected luminance data (D1 to Dn) corresponding to the driving levels X1 to Xn of each pattern are detected by the luminance meter 2, and memorized in the RAM 1c (step S301: luminance detecting step), the CPU 1a interpolates the luminance data corresponding to all of the driving levels (x1 to Xm) of the monitor 1e to obtain the interpolated luminance data (d1 to dm), based on the detected data and the gradation of each pattern, (step S302: characteristic data forming step), and proceeds to step S303.

In step S303, CPU 1a judges whether section xk decreasing with the increase of the driving level exists in the interpolated luminance data or not, and when there exists the decreasing section xk, CPU 1a proceeds to step S304, and if not, CPU 1a proceeds to step S305 to complete the calculation of the characteristic data.

In step S304, when a pair of two detected luminance data with the decreasing section xk being between, correspond to the driving levels Xj to X(j+1), the CPU 1a increases the value of the detected luminance datum D(j+1), which corresponds to the driving level X(j+1) having a higher value, by ΔD, and proceeds to step S302. Here, there are three selected data which are the detected luminance datum D (j+1) to be corrected, and a paired two detected luminance data (Dj, D (j+2)) before and after the detected luminance datum D (j+1) to be corrected, so that the AD is obtained by the three selected values. For example, in the present embodiment, AD is obtained by the average of the three values of which the weightings are changed. (ΔD=α×Dj+β×D(j+1)+γ×D(j+2)−D(j+1)), here, α+β+γ=1, and the more preferable is β>α, β>γ.

Incidentally, though there was described the case where the detected luminance data to be detected are increased, the ΔD can be calculated by the same method as the above, even in the case where those are decreased.

### EXAMPLE 4

In the Examples 1 to 3, one detected luminance datum is corrected so that the characteristic data are formed to be the monotonous increase and the monotonous decrease, however in the Example 4, a plurality of the detected luminance data (gradation measurement data) are corrected so that the characteristic data are formed to be the monotonous increase and the monotonous decrease.

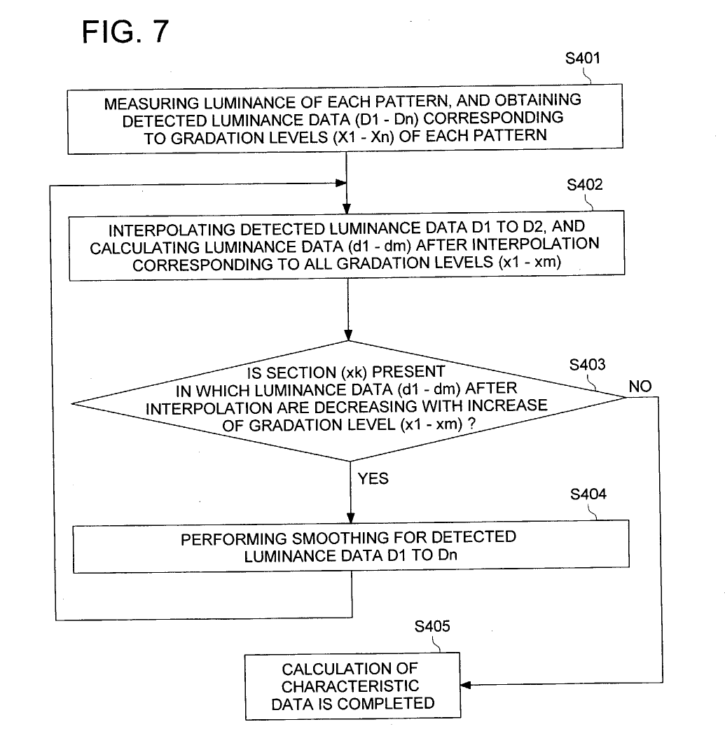

To put it concretely, as shown in FIG. 7, the detected luminance data (D1 to Dn) corresponding to the driving levels X1 to Xn of each pattern are detected by the luminance meter 2, and are memorized in the RAM 1c (step S401: luminance detecting step), next, the CPU 1a interpolates the luminance data corresponding to all of the driving levels (x1 to xm) of the monitor 1e, based on the detected luminance data and the gradations of each pattern, and obtains the luminance data (d1 to dm) after the interpolation (step S402: the characteristic data forming step), and proceeds to step S403.

In the step 403, the CPU 1a judges whether the section xk decreasing with the increase of the driving level, exists or not in the luminance data after the interpolation, and if the decreasing section xk exists, the CPU 1a proceeds to step S404, and if not, proceeds to step 405, to complete the calculation of the characteristic data.

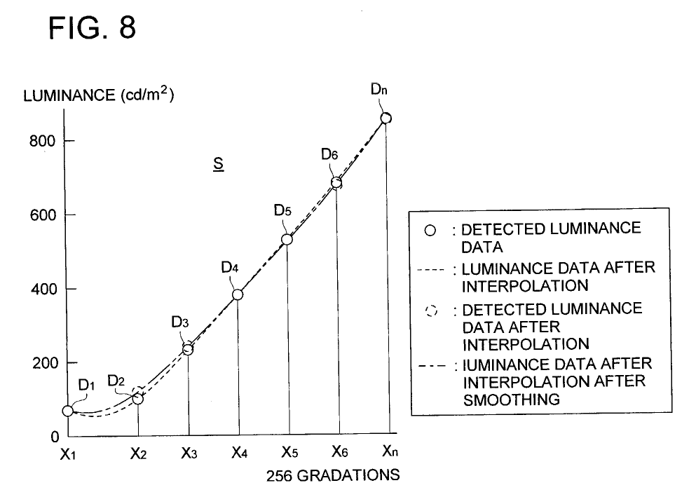

In the step S404, CPU 1a performs the smoothing (regulation) so that the luminance data increase smoothly with the increase of the gradation, based on the detected luminance data and the gradation of each pattern. When the smoothing is performed as mentioned above, each of the luminance data is corrected respectively as shown in FIG. 8, which is different from the cases of the above-mentioned Examples 1 to 3 in which one luminance datum only changes, and the CPU 1a proceeds to step S402.

As mentioned above, in the Example 4, when the section xk decreasing with the increase of the driving level exists, the detected luminance data D1 to Dn are smoothed so that the characteristic data are formed to be the monotonous increase.

Here, in the structures of the above-mentioned Examples 1 to 3, there is possibility that though the number of the detected luminance data to be corrected is small, the correction amount of the luminance data to be corrected is large, however, in the present Example 4, there is possibility that though the number of the detected luminance data to be corrected is large, the correction amount of the luminance data to be corrected are small.

### EXAMPLE 5

Example 5 shows the method to eliminate the section where the luminance data (gradation measurement data) decrease, and not to correct to be the monotonous increase, when the section where the luminance data decrease corresponds to the driving level that is higher than the driving level with which the luminance datum obtains the greatest value, under the condition that the relation shown in the characteristic data has the increasing tendency, and that there is the section in which the luminance data decrease with the increase of the driving level.

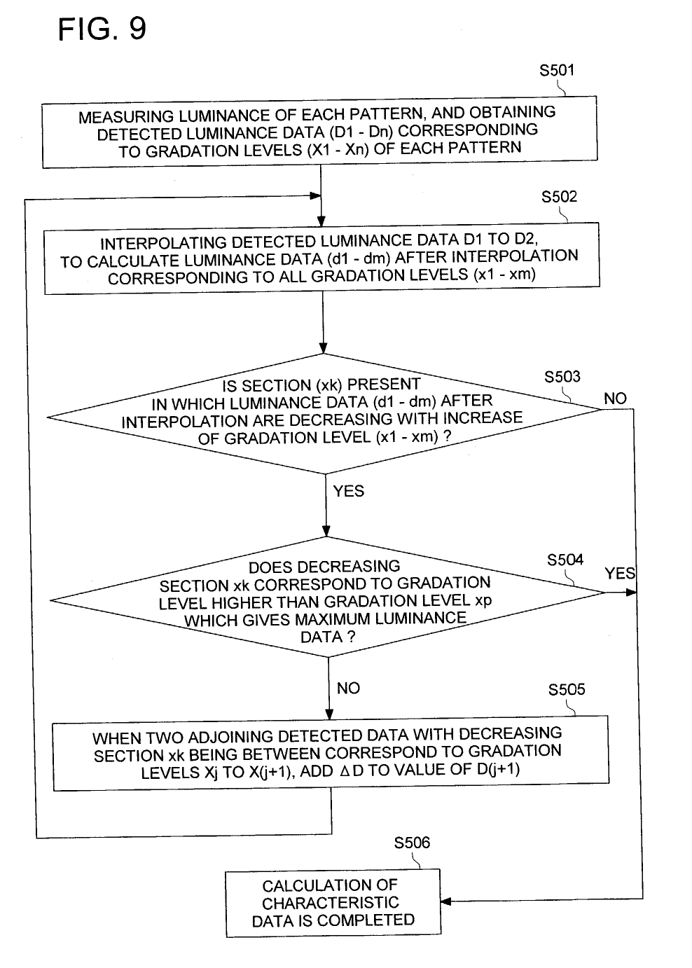

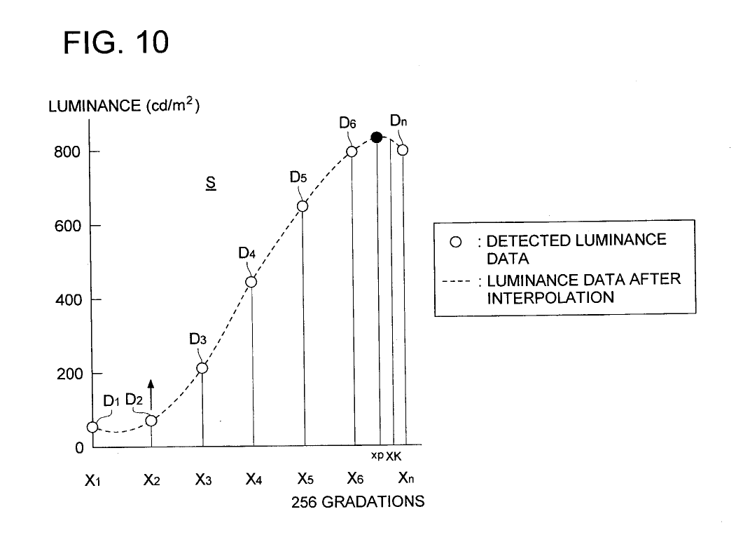

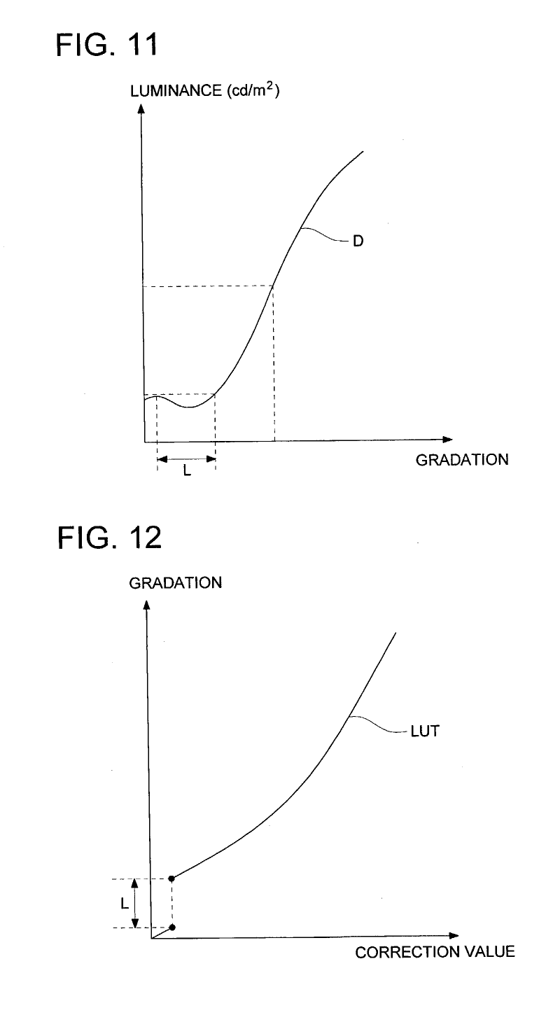

To put it concretely, as shown in FIG. 9, when the detected luminance data (D1 to Dn) corresponding to the driving levels X1 to Xn of each pattern are detected by the luminance meter 2, and are memorized in the RAM 1c (step S501: the luminance detection step), the CPU 1a interpolates the luminance data corresponding to all of the driving levels (x1 to xm) of the monitor 1e, based on the detected luminance data and the gradations of each pattern, then, obtains the luminance data (d1 to dm) after the interpolation (step S502: the characteristic data forming step), and proceeds to step S503. FIG. 10 is a gradation—luminance diagram showing the luminance data after the interpolation and the detected luminance data.

In the step 503, the CPU 1a judges whether the section xk decreasing with the increase of the driving level, exists or not in the interpolated luminance data after the interpolation, and when the decreasing section xk exists, the CPU 1a proceeds to step S504, and if not, proceeds to step 505, to complete the calculation of the characteristic data.

In the step 504, when the section xk decreasing with the increase of the driving level, corresponds to the driving level that is higher than driving level xp by which the luminance datum is the greatest value, the CPU 1a proceeds to step 506 so that the section where luminance data decreased may be eliminated, and a correction creating monotonous increase may not be conducted, and completes the calculation of the characteristic data, and if the section does xk is smaller than the driving level xp, CPU 1a proceeds to step S505.

Further, in the step 505, if a pair of two detected luminance data with the decreasing section xk being between are composed of the driving levels Xj to X (j+1), the CPU 1a increases the value of the detected luminance datum D(j+1) which corresponds to the driving level X(j+1) having a higher value, by ΔD, and proceeds to the step S502. Here, ΔD is a predetermined constant value.

Incidentally, when the relationship shown in the characteristic data has the decreasing tendency, and when there is a section in which the luminance data increase with the increase of the driving level, if the luminance data increasing section corresponds to the driving level which is higher than the driving level in which the luminance level obtains a minimum value, there is no need to perform the correction to create a monotonous decrease, by eliminating the section where the luminance data increase.

In a look-up table forming step, the CPU 1a forms a look-up table, based on the characteristic data showing the monotonous increase or the monotonous decrease, obtained by the above-mentioned method. Here, the look-up table is the one which shows the relation between the driving level and the gradation level of the image data so that the driving level and the gradation level of the image data are changed to be an intended gradation (for example, nearly proportional, proportional to the driving level to the power of 2.2, which is the characteristic of the normal CRT, or GSDF characteristic of DICOM PART 14).

Incidentally, there is a case that the characteristic data obtained in the Example 5 are not formed to be the monotonous increase or the monotonous decrease, but in this case, the look-up table can be formed, based on the characteristic data which are not formed to be the monotonous increase or the monotonous decrease.

Further, the image data which are outputted on the monitor 1e are corrected, based on the look-up table. To put it concretely, the gradation corresponding to each luminance are selected from the characteristic data showing the monotonous increase or the monotonous decrease, and then the image data to be outputted are corrected, based on the selected gradation.

As mentioned above, according to the calibration device of the present embodiment, the correcting step forms the second characteristic data of the imaging apparatus again, by correcting the detected density or luminance data in a way that the increase of the density or luminance data after an interpolation becomes monotonous increase, when the density or luminance data after the interpolation have an increasing tendency with the increase of the driving level, but the density or luminance data after the interpolation do not show a monotonous increase, on the other hand, the correcting step forms the second characteristic data of the imaging apparatus, by correcting the detected density or luminance data in a way that the decrease of the density or luminance data after an interpolation becomes monotonous decrease, when the density or luminance data after the interpolation have a decreasing tendency with the increase of the driving level, but the density or luminance data after the interpolation do not show a monotonous decrease, and accordingly, the second characteristic data formed after the correction show either one of the relationships of the monotonous increase or the monotonous decrease, and thereby, when the look-up table is formed, based on the second characteristic data, the corrected value is not discontinuous. Accordingly, if the image data are corrected by the formed look-up table, it is possible to output the image in which the false contour is not generated.

Incidentally, the present invention is naturally changeable without being limited to the above-mentioned embodiments. For example, in the present embodiments, when the luminance data after the interpolation are not the monotonous increase or the monotonous decrease, the detected luminance data are corrected, however, even when the detected luminance data are not the monotonous increase or the monotonous decrease, the correction can be performed.

Further, when the luminance data having been corrected in the correction step are corrected beyond the predetermined range to the luminance data before the correction, it is possible to adopt the structure having a warning device. By this structure, when the luminance data having been corrected are corrected beyond the predetermined range to the luminance data before the correction, for example, there is a high possibility of abnormality that the gradation of the outputted image were not read out correctly by an influence of light for illumination when the luminance is detected, and therefore, the look-up table can be formed more correctly, if the redetection of the luminance of the outputted image is performed, with the warning and the changing of the luminance detecting circumstance or the detecting condition.

Further, concerning the warning process means, when there are shown the relationship wherein the luminance data after the interpolation have the increasing tendency with the increase of the driving level, and wherein the luminance data after the interpolation are not the monotonous increase, in the characteristic data formed in the characteristic data forming step, or when there are shown the relationship wherein the luminance data after the interpolation have the decreasing tendency with the increase of the driving level, and wherein the luminance data after the interpolation are not the monotonous decrease, in the characteristic data formed in the characteristic data forming step, the warning step that performs the warning can be provided in CPU 1a after the characteristic forming step.

By the above-mentioned structure, when there are shown the relationship wherein the luminance data after the interpolation have the increasing tendency with the increase of the driving level, and wherein the luminance data after the interpolation are not the monotonous increase, in the characteristic data formed in the characteristic data forming step, or when there are shown the relationship wherein the luminance data after the interpolation have the decreasing tendency with the increase of the driving level, and wherein the luminance data after the interpolation are not the monotonous decrease, in the characteristic data formed in the characteristic data forming step, the warning is performed, and thereby, the redetection of the luminance for the image for the luminance measurement can be performed, before the look-up table that generates the false contour is formed.

Further when the above-mentioned circumstance is the one that is generated by the circumstance or condition of the detection, it is possible to prevent the generation of the false contour when the image is outputted, by the change of the detecting circumstance or the detecting condition for the redetection.

Incidentally, in this case, it is possible to arrange the look-up table forming step, wherein the relation of the luminance level and the gradation level of the image data are expressed so that the driving level and the gradation level of the image data are in the predetermined relation, based on the characteristic data.

Still further, in the present embodiments, the correcting method that is performed in the correcting step, and the warning step are described separately, however, it is possible to adopt the structure in which these methods are combined.

Still further, it is possible to offer the program by which the computer can perform a series of the processes of the calibration device in the present embodiments, and it is possible to offer via the memory media such as CD-ROM or Floppy (registered trademark) disk or the communication network, in this case.

Though the display monitor is used in the above-mentioned embodiments, the present invention can be also applied to the calibration method in which a wedge pattern on a photographic film is developed and its transmittance density is measured.

By the invention described in Structure (1), the characteristic data formed after the correction show either one of the relations of the monotonous increase or the monotonous decrease, and thereby, even when the look-up table is formed, based on the characteristic data, the corrected data are not discontinuous. Accordingly, if the image data are corrected with the formed look-up table, the image in which the false contour is not generated can be outputted.

By the invention described in Structure (4), it is possible to obtain the effect that is the same as that of the invention described in Structure (1). Incidentally, in the Structures (2) and (3), there is possibility that the correction amount of the luminance data to be corrected becomes large, though the number of the luminance data to be corrected is small, on the other hand, in the Structure (4), there is possibility that the correction amount of the luminance data to be corrected becomes small, though the number of the luminance data to be corrected is large.

By the invention described in Structure (5), it is possible to obtain the effect that is the same as that of the invention described in Structures (1) to (4).

Further, in the above-mentioned increasing tendency, when the decreasing section of the density or luminance level exists on a section whose driving level is higher than the driving level which gives a maximum value of the density or luminance level, the false contour is not generated, because the density or luminance level that is higher than the maximum value does not exist, though the decreasing section of the density or luminance level is disregarded.

Similarly, in the case of the above-mentioned decreasing tendency, when the increasing section of the density or luminance level exists on a section whose driving level is higher than the driving level which gives a minimum value of the density or luminance level, the false contour is not generated, because the density or luminance level that is lower than the minimum value does not exist, though the increasing section of the density or luminance level is disregarded.

Accordingly, in the above-mentioned case, even when the look-up table is made without correcting the density or luminance data, the density or luminance data are not corrected, because the false contour is not generated, and thereby, the process is simplified so that the time for the process can be shortened.

By the invention described in Structure (6), when the corrected density or luminance data are corrected beyond the prescribed range from the density or luminance data before the correction, there is a high possibility of an abnormal condition, for example, that the gradation of the output image was not read out correctly under the influence of light such as an illumination light in the course of the density or luminance detection. In this case, however, if the density or luminance of the output image is detected again, by giving a warning and by changing the detecting circumstance and the detecting condition for the density or luminance, for example, the more accurate look-up table can be made.

By the invention described in Structure (7), the density or luminance of the outputted image can be detected again, before the look-up table which will cause the false contour is made. Further, if the above-mentioned circumference is created by the circumference or the condition in the course of the detection, it is possible to prevent the generation of the false contour when the image is outputted, by changing the detecting circumference and the detecting condition for re-detection.

What is claimed is:

1. A calibration device for calibrating an imaging apparatus which outputs a visual image in response to inputted image data, on a basis of a plurality of driving test levels and a plurality of gradation measurement data obtained by measuring a plurality of visual images corresponding to the plurality of driving test levels, comprising:
a first characteristic forming section to interpolate the plurality of gradation measurement data so as to produce a plurality of gradation interpolation data and to form a first characteristic between all driving levels and gradation data on a basis of both of the plurality of gradation measurement data and the plurality of gradation interpolation data;
a correcting section to correct the first characteristic in the case that the first characteristic does not show a monotonous increase or decrease in gradation data with increase of driving levels and to form a second characteristic so as to show a monotonous increase or decrease in gradation data with increase of driving levels; and
a look-up table making section to make a look-up table showing relation between all driving levels and inputted image data on the basis of the second characteristic so as to maintain predetermined relation between the inputted image data and the outputted visual images.

2. A calibration device for calibrating an imaging apparatus which outputs a visual image in response to inputted image data, on a basis of a plurality of driving test levels and a plurality of gradation measurement data obtained by measuring a plurality of visual images corresponding to the plurality of driving test levels, comprising:
a first characteristic forming section to interpolate the plurality of gradation measurement data so as to produce a plurality of gradation interpolation data and to form a first characteristic between all driving levels and gradation data on a basis of both of the plurality of gradation measurement data and the plurality of gradation interpolation data;
a correcting section to correct the first characteristic in the case that the first characteristic does not show a monotonous increase or decrease in the gradation measurement data with increase of the driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level; and
a look-up table making section to make a look-up table showing relation between all driving levels and inputted image data on the basis of the second characteristic so as to maintain predetermined relation between the inputted image data and the outputted visual images.

3. The calibration device of claim 2,
wherein when the gradation data shown in the first characteristic has the increasing tendency,
the correcting section forms the second characteristic by performing at least either one of corrections to the first characteristic, which are
an increasing correction wherein, between adjoining gradation measurement data of a decreased section of the gradation interpolation data with the increase of the driving level, the gradation measurement datum corresponding to a higher driving level is increased up to the level where the relation shown in the characteristic becomes the monotonous increase, and
a decreasing correction wherein, between adjoining gradation measurement data of a decreased section of the gradation interpolation data with the increase of the driving level, the gradation measurement datum corresponding to a lower driving level is decreased down to the level where the relation shown in the characteristic becomes the monotonous increase, on the other hand, when the gradation data shown in the first characteristic has a decreasing tendency,
the correcting section forms the second characteristic by performing at least either one of corrections to the first characteristic, which are
a decreasing correction wherein between adjoining gradation measurement data of an increased section of the gradation interpolation data with the increase of the driving level, the gradation measurement datum corresponding to a higher driving level is decreased down to the level where the relation shown in the characteristic becomes the monotonous decrease, and
an increasing correction, wherein between adjoining gradation measurement data of an increased section of the gradation interpolation data with the increase of the driving level, the gradation measurement datum corresponding to a lower driving level is increased up to the level where the relation shown in the characteristic becomes the monotonous decrease.

4. The calibration device of claim 3, wherein the correcting section corrects the gradation measurement datum, based on the datum before the correction of the gradation measurement datum, and a plurality of neighboring gradation measurement data.

5. The calibration device of claim 2, wherein when the gradation measurement data shown in the first characteristic have the increasing tendency, the correcting section performs smoothing of a plurality of the gradation measurement data, until the relation in the second characteristic becomes the monotonous increase, on the other hand, when the gradation measurement data shown in the first characteristic have the decreasing tendency, the correcting section performs smoothing of a plurality of the gradation measurement data, until the relation in the second characteristic becomes the monotonous decrease.

6. The calibration device of claim 2, wherein, in case that the relation in the first characteristic has the increasing tendency, and further there is a section where the gradation measurement data decrease with the increase of the driving level,
when the section where the gradation measurement data decrease corresponds to the driving level that is higher than the driving level wherein the gradation measurement datum has a maximum value,
the correcting section does not perform the monotonous increasing correction to the first characteristic, on the other hand, wherein in case that the relation in the first characteristic has the decreasing tendency, and further there is a section where the gradation measurement data increase with the increase of the driving level,
when the section where the gradation measurement data increase corresponds to the driving level that is higher than the driving level wherein the gradation measurement datum has a minimum value, the correcting section does not perform the monotonous decreasing correction for the first characteristic, and
the look-up table making section makes the look-up table based on the second characteristic wherein the second characteristic are not the monotonous increase or the monotonous decrease.

7. The calibration device of claim 2, comprising;
a warning section for performing a warning process, when correction beyond a predetermined range is adopted to the gradation measurement data.

8. A calibration device for calibrating an imaging apparatus which outputs a visual image in response to inputted image data, on a basis of a plurality of driving test levels and a plurality of gradation measurement data obtained by measuring a plurality of visual images corresponding to the plurality of driving test levels, comprising;
a first characteristic forming section to interpolate the plurality of gradation measurement data so as to produce a plurality of gradation interpolation data and to form a first characteristic between all driving levels and gradation data on a basis of both of the plurality of gradation measurement data and the plurality of gradation interpolation data;
a look-up table making section for making a look-up table showing relation between all driving levels and inputted image data, based on the first characteristic so as to maintain predetermined relation between the inputted image data and the outputted visual images; and
a warning process section for performing a warning process, before making the look-up table,
when the first characteristic shows an increasing tendency of the gradation measurement data with the increase of the driving level, and shows that the gradation measurement data are not a monotonous increase, or
when the first characteristic shows a decreasing tendency of the gradation measurement data with the increase of the driving level, and shows that the gradation measurement data are not a monotonous decrease.

9. A calibration method of an image output apparatus, comprising;
a gradation measurement data detecting step for reading out gradation measurement data of visual images outputted by an imaging apparatus;
a first characteristic forming step to interpolate a plurality of the gradation measurement data so as to produce a plurality of gradation interpolation data and to form a first characteristic between all driving levels and gradation data on a basis of both of the plurality of gradation measurement data and the plurality of gradation interpolation data;
a correcting step to correct the first characteristic in the case that the first characteristic does not show a monotonous increase or decrease in the gradation measurement data with increase of driving levels, and to form a second characteristic so as to show a monotonous increase in gradation data with an increase of the driving level, though the first characteristic has an increasing tendency, but is not the monotonous increase with the increase of the driving level, or so as to show a monotonous decrease in the gradation data with the increase of the driving level, though the first characteristic has a decreasing tendency, but is not the monotonous decrease with the increase of the driving level; and
a look-up table making step to make a look-up table showing relation between all driving levels and inputted image data on the basis of the second characteristic so as to maintain predetermined relation between the inputted image data and the outputted visual images.

10. A calibration method of an image output apparatus, comprising;
a gradation measurement data detecting step for reading out gradation measurement data of visual images outputted in response to inputted image data, on a basis of a plurality of driving test levels and a plurality of gradation measurement data obtained by measuring a plurality of visual images corresponding to the plurality of the driving test levels, comprising;
a first characteristic forming step to interpolate the plurality of the gradation measurement data so as to produce a plurality of gradation interpolation data and to form a first characteristic between all driving levels and gradation data on a basis of both of the plurality of the gradation measurement data and the plurality of gradation interpolation data;
a look-up table making step for making a look-up table showing the relation between the driving level and a gradation of the inputted image data, based on the first characteristic; and
a warning process step for performing a warning process, before making the look-up table, when the first characteristic shows an increasing tendency of the gradation measurement data with an increase of the driving level, and shows that the gradation measurement data are not a monotonous increase, or when the first characteristic shows a decreasing tendency of the gradation measurement data with the increase of the driving level, and shows that the gradation measurement data are not a monotonous decrease.

11. A program for a computer to perform a calibration process of an imaging apparatus, on a basis of a plurality of driving test levels and a plurality of gradation measurement data obtained by measuring a plurality of visual images corresponding to the plurality of the driving test levels, comprising;
a first characteristic forming function to interpolate the plurality of the gradation measurement data so as to produce a plurality of gradation interpolation data and to form a first characteristic between all driving levels and gradation data on a basis of both of the plurality of the gradation measurement data and the plurality of the gradation interpolation data;
a correcting function to correct the first characteristic in the case that the first characteristic does not show a monotonous increase or decrease in gradation measurement data with increase of driving levels and to form a second characteristic so as to show a monotonous increase in gradation data with an increase of the driving level, though the first characteristic has an increasing tendency, but is not the monotonous increase with the increase of the driving level, or so as to show a monotonous decrease in the gradation data with the increase of the driving level, though the first characteristic has a decreasing tendency, but is not the monotonous decrease with the increase of the driving level; and
a look-up table making function to make a look-up table showing relation between all driving levels and inputted image data on the basis of the second characteristic so as to maintain predetermined relation between the inputted image data and the outputted visual images.

12. A program for a computer to perform calibration process of an imaging apparatus, on a basis of a plurality of driving test levels and a plurality of gradation measurement data obtained by measuring a plurality of visual images corresponding to the plurality of the driving test levels, comprising;
a first characteristic forming function to form a first characteristic between all driving levels and gradation data on a basis of both of the plurality of the gradation measurement data and the plurality of the driving levels;
a look-up table making section to make a look-up table showing relation between all driving levels and inputted image data on the basis of the characteristic so as to maintain predetermined relation between the inputted image data and the outputted visual images; and
a warning process function for performing a warning process, before making the look-up table,
when the first characteristic shows an increasing tendency of the gradation measurement data with the increase of the driving level, and shows that the gradation measurement data are not a monotonous increase, or when the first characteristic shows a decreasing tendency of the gradation measurement data with the increase of the driving level, and shows that the gradation measurement data are not a monotonous decrease.

13. A calibration device for calibrating an imaging apparatus which outputs a visual image in response to inputted image data, on a basis of a plurality of driving levels and a plurality of gradation measurement data obtained by measuring a plurality of visual images corresponding to the plurality of driving levels, comprising:
a first characteristic forming section to form a first characteristic between gradation measurement data and the plurality of the driving levels;
a correcting section to correct the first characteristic in the case that the first characteristic does not show a monotonous increase or decrease in gradation measurement data with increase of driving levels and to form a second characteristic so as to show a monotonous increase in gradation data with an increase of the driving level, though the first characteristic has an increasing tendency, but is not the monotonous increase with the increase of the driving level, or so as to show a monotonous decrease in gradation data with the increase of the driving level, though the first characteristic has a decreasing tendency, but is not the monotonous decrease with the increase of the driving level; and
a look-up table making section to make a look-up table showing relation between driving levels and inputted image data on the basis of the second characteristic so as to maintain predetermined relation between the inputted image data and the outputted visual images.

14. The calibration device of claim 13,
wherein when the first characteristic has the increasing tendency, the correcting section forms the second characteristic by performing at least either one of corrections to the first characteristic, which are
an increasing correction wherein, when the gradation measurement data do not increase monotonously with the increase of the driving level, the gradation measurement datum corresponding to a higher driving level is increased up to the level where the relation shown in the characteristic becomes the monotonous increase, and
a decreasing correction wherein, when the gradation measurement data do not decrease monotonously with the increase of the driving level, the gradation measurement datum corresponding to a lower driving level is decreased down to the level where the relation shown in the characteristic becomes the monotonous increase,
on the other hand, wherein, when the gradation data shown in the first characteristic has a decreasing tendency, the correcting section forms the second characteristic by performing at least either one of corrections to the first characteristic, which are
a decreasing correction wherein, when the gradation measurement data do not decrease monotonously with the increase of the driving level, the gradation measurement datum corresponding to a higher driving level is decreased down to level where the relation shown in the characteristic becomes the monotonous decrease, and
an increasing correction wherein, when the gradation measurement data do not decrease monotonously with the increase of the driving level, the gradation measurement datum corresponding to a lower driving level is increased up to the level where the relation shown in the characteristic becomes the monotonous decrease.

15. The calibration device of claim 14, wherein the correcting section corrects the gradation measurement datum, based on the datum before the correction of the gradation measurement datum, and a plurality of neighboring gradation measurement data.

16. The calibration device of claim 13, wherein when the gradation measurement data shown in the first characteristic have the increasing tendency, the correcting section performs smoothing of a plurality of the gradation measurement data, until the relation expressed in the second characteristic becomes the monotonous increase,
on the other hand, when the gradation measurement data shown in the first characteristic have the decreasing tendency, the correcting section performs smoothing of a plurality of the gradation measurement data, until the relation in the second characteristic becomes the monotonous decrease.

17. The calibration device of claim 13, wherein, in case that the relation in the first characteristic has the increasing tendency, and further there is a section where the measured data decrease with the increase of the driving level,
when the section where the gradation measurement data decrease, corresponds to the driving level that is higher than the driving level wherein the gradation measurement datum has a maximum value, the correcting section does not perform the monotonous increasing correction to the first characteristic, on the other hand, wherein in case that the relation in the first characteristic has the decreasing tendency, and further there is a section where the gradation measurement data increase with the increase of the driving level, when the section where the gradation measurement data increase corresponds to the driving level that is higher than the driving level wherein the gradation measurement datum has a minimum value, the correcting section does not perform the monotonous decreasing correction for the first characteristic, and
the look-up table making section makes the look-up table based on the second characteristic wherein the second characteristic are not the monotonous increase or the monotonous decrease.

18. The calibration device of claim 13, comprising;
a warning section for performing a warning process, when the gradation measurement data are corrected beyond a predetermined range.

19. A calibration device for calibrating an imaging apparatus which outputs a visual image in response to inputted image data, on a basis of a plurality of driving levels and a plurality of gradation measurement data obtained by measuring a plurality of visual images corresponding to the plurality of driving levels, comprising;
a first characteristic forming section to form a first characteristic which shows a relation between the driving levels and the gradation measurement data;
the look-up table making section for making a look-up table showing relation between driving levels and inputted image data, based on the first characteristic so as to maintain predetermined relation between the inputted image data and the outputted visual images; and
a warning process section for performing a warning process, before making the look-up table,
when the first characteristic shows an increasing tendency of the gradation measurement data with the increase of the driving level, and shows that the gradation measurement data are not a monotonous increase, or when the first characteristic shows a decreasing tendency of the gradation measurement data with the increase of the driving level, and shows that the gradation measurement data are not a monotonous decrease.

20. A calibration method of an image output apparatus, comprising;
a gradation measurement data detecting step for reading out gradation measurement data of visual images outputted by an imaging apparatus;
a first characteristic forming step to form a first characteristic on a basis of both of the plurality of gradation measurement data and the plurality of driving levels;
a correcting step to correct the first characteristic in the case that the first characteristic does not show a monotonous increase or decrease in the gradation measurement data with increase of driving levels and to form a second characteristic so as to show a monotonous increase in gradation measurement data with an increase of the driving level, though the first characteristic has an increasing tendency, but is not the monotonous increase, with the increase of the driving level, or so as to show a monotonous decrease in the gradation measurement data with the increase of the driving level, though the first characteristic has a decreasing tendency, but is not the monotonous decrease with the increase of the driving level; and
a look-up table making step to make a look-up table showing relation between driving levels and inputted image data on the basis of the second characteristic so as to maintain predetermined relation between the inputted image data and the outputted visual images.

21. A calibration method of an image output apparatus, comprising;
a gradation measurement data detecting step for reading out gradation measurement data of visual images outputted in response to inputted image data, on a basis of a plurality of driving levels and a plurality of gradation measurement data obtained by measuring a plurality of visual images corresponding to the plurality of the driving levels, comprising;
a first characteristic forming step to form a first characteristic on a basis of both of the plurality of gradation measurement data and the plurality of the driving levels;
a look-up table making step for making a look-up table showing the relation between the driving level and a gradation level of the image data, based on the first characteristic; and
a warning process step for performing a warning process, before making the look-up table,
when the first characteristic shows an increasing tendency of the gradation measurement data with an increase of the driving level, and shows that the gradation measurement data are not a monotonous increase, or when the first characteristic shows a decreasing tendency of the gradation measurement data with the increase of the driving level, and shows that the gradation measurement data are not a monotonous decrease.
